(19) United States
(12) Patent Application Publication
(10) Pub. No.: US 2007/0188575 A1
(43) Pub. Date: Aug. 16, 2007

(54) Ink-jet recording apparatus

(75) Inventor: Yusuke Nakazawa, Haibara-gun (JP)

Correspondence Address: SUGHRUE-265550, 2100 PENNSYLVANIA AVE. NW, WASHINGTON, DC, 20037-3213, US

(73) Assignee: FUJIFILM Corporation, Minato-ku (JP)

(21) Appl. No.: 11/703,655

(22) Filed: Feb. 8, 2007

(30) Foreign Application Priority Data
Feb. 10, 2006 (JP) 2006-034078

(51) Int. Cl. B41J 2/01

(52) U.S. Cl. 347/102

(57) ABSTRACT

An ink-jet recording apparatus includes: a recording medium transporting portion that transports a web-like recording medium; an ink-jet heads that include a nozzle portion and ejects an ink on the basis of an image signal toward the web-like recording medium transported by the recording medium transporting portion, the ink being curable by active energy rays; an active energy irradiating portion that comprises a light source irradiating the active energy rays and cures the ink ejected onto the web-like recording medium by the active energy rays irradiated from the light source; and a transporting direction changing portion that is disposed right by at least one of an upstream and downstream sides of the active energy irradiating portion in the transporting direction of the recording medium at a position between ink-jet heads, and that changes a transporting direction of the recording medium to a direction vertical to the transporting direction.

### BACKGROUND OF THE INVENTION

1. Field of the Invention

The present invention relates to an ink-jet recording apparatus in which an ink curable by active energy rays such as ultraviolet rays, electron beams, or the like is used, and image formation is performed on a recording medium by an ink-jet head, and more particularly to an ink-jet recording apparatus in which stray light in exposure is prevented from reaching a nozzle portion of a head.

2. Background Art

An ink-jet apparatus in which an ink curable by energy rays such as ultraviolet rays, electron beams, or the like is ejected onto a recording medium by using an ink-jet head, and the ink is cured by irradiation of energy, thereby forming an image has features such as that the apparatus is good for the environment, that high-speed recording can be performed on various recording media, and that a high-resolution image which hardly blurs is obtained. Particularly, the development of an apparatus which uses an ultraviolet curable ink is being advanced from the viewpoints of easy handling of a light source, compactness, and the like. Particularly, a so-called single-pass ink-jet apparatus has been developed with using the high-speed fixing property of such an ink. In the apparatus, a web-like recording medium which can be transported at a high speed is employed, a head having a width which allows recording to be performed over the whole width of the recording medium is opposed to the recording medium in a fixed state, and recording is completed by only a single pass of the recording medium under the head.

FIG. 3 is a diagram of conventional example 1 of an ink-jet recording apparatus.

In the active energy curable ink-jet recording apparatus 30 shown in FIG. 3, a web-like recording medium S is taken out from a feed roller 31 around which the recording medium S is wound in a roll-like manner. During transportation under a K (black) color full-line head 33K in which many ink-jet nozzles are arranged in the width direction of the recording medium S, a K-color ink is recorded in an image-like manner onto the recording medium S. During transportation under a C (cyan) color full-line head 33C in which many ink-jet nozzles are arranged in the width direction of the recording medium S, then, a C-color ink is recorded in an image-like manner onto the recording medium S. During transportation under an M (magenta) color full-line head 33M in which many ink-jet nozzles are arranged in the width direction of the recording medium S, an M-color ink is recorded in an image-like manner onto the recording medium S. During transportation under a Y (yellow) color full-line head 33Y in which many ink-jet nozzles are arranged in the width direction of the recording medium S, a Y-color ink is recorded in an image-like manner onto the recording medium S. The recording medium S onto which four color inks have been ejected is then passed under active-energy irradiating portion (in the example, including an ultraviolet curing lamp) 34. During the passing, the recording medium receives active energy to be subjected to a fixing process, and is then rewound by a take-up roller 32. In FIG. 3, transportation rollers are arranged under the recording medium S, and a carry-in roller 35 and a carry-out roller 36 are provided for each of the full-line heads 33K to 33Y. With respect to the full-line head 33K, the feed roller 31 may be used also as a substitute for the carry-in roller 35. A transportation roller 37 is a direction changing roller.

As described above, in the color printing by the single-pass ink-jet apparatus of FIG. 3, the fixed heads (in the example, for the four colors) the number of which is equal to that of colors are arranged in the transporting direction of the recording medium. In this case, color mixture occurs among the different color inks K, C, M, Y. When the fixing process is performed after color mixture, the resulting color is different from the original one.

In the configuration disclosed in JP-A-2004-314586, in order to prevent such color mixture from occurring, light irradiating portion is disposed downstream of each of color heads.

FIG. 4 is a diagram of conventional example 2 of an ink-jet recording apparatus in which a measure for preventing color mixture from occurring is taken.

In the ink-jet recording apparatus 40 shown in FIG. 4, a web-like recording medium S is taken out from a feed roller 41 around which the recording medium S is wound in a roll-like manner. During transportation under a K-color full-line head 43K in which many ink-jet nozzles are arranged in the width direction of the recording medium S, a K-color ink is recorded in an image-like manner onto the recording medium S. Immediately after the recording, the recording medium S is passed under active-energy irradiating portion 44K to receive active energy, and the K-color ink is fixed. During transportation under a next ink or C-color full-line head 43C, then, a C-color ink is recorded in an image-like manner onto the recording medium S. Immediately after the recording, the recording medium S is passed under active-energy irradiating portion 44C, and the C-color ink is fixed. During transportation under an M-color full-line head 43M, similarly, an M-color ink is recorded in an image-like manner onto the recording medium S. Immediately after the recording, the recording medium S is passed under active-energy irradiating portion 44M, and the M-color ink is fixed. During transportation under a Y-color full-line head 43Y, finally, a Y-color ink is recorded in an image-like manner onto the recording medium S. Immediately after the recording, the recording medium S is passed under active-energy irradiating portion 44Y, and the Y-color ink is fixed. Thereafter, the recording medium is rewound by a take-up roller 42.

In the figure, transportation rollers are arranged under the recording medium S, and a carry-in roller 45 and a carry-out roller 46 are provided for each of the full-line heads 43K to 43Y. With respect to the full-line head 43K, the feed roller 41 may be used also as a substitute for the carry-in roller 45. A transportation roller 47 is a direction changing roller.

As described above, in the conventional example 2 shown in FIG. 4, immediately after each of the ejections of the K-, C-, M-, and Y-inks onto the recording medium S, the fixing process is performed. Therefore, color mixture among the inks does not occur, and a finely finished image can be obtained.

On the other hand, however, the active-energy irradiating portion 44K to 44Y are placed at positions immediately downstream from the ink-jet heads 43K to 43Y, respectively. Therefore, stray light from the active-energy irradiating portion 44K to 44Y drifts to impinge on nozzle portions of the adjacent ink-jet heads 43K to 43Y. As a result, there arises a problem in that the inks in the nozzle portions are hardened to block the nozzle portions, with the result that the nozzle portions cannot be used.

In an apparatus of a high productivity, the time period of active energy irradiation is short, and hence the irradiation level must be raised. Therefore, the problem is particularly serious. In the case where a recording medium producing a large amount of reflected light, such as a recording medium having metallic luster or a surface-smoothed recording medium is used, the problem is more serious.

### SUMMARY OF THE INVENTION

It is an object of the invention to provide an ink-jet recording apparatus in which the productivity is high, recording can be performed on various recording media, an ink in a nozzle portion is not hardened, and the life period is long. (1) According to an aspect of the invention, an ink-jet recording apparatus comprising: a recording medium transporting portion that transports a web-like recording medium; ink-jet heads that comprise a nozzle portion and ejects an ink on the basis of an image signal toward the web-like recording medium transported by the recording medium transporting portion, the ink being curable by active energy rays; an active energy irradiating portion that comprises a light source irradiating the active energy rays and cures the ink ejected onto the web-like recording medium by the active energy rays irradiated from the light source; and a transporting direction changing portion that is disposed right by at least one of an upstream and downstream sides of the active energy irradiating portion in the transporting direction of the recording medium at a position between ink-jet heads, and that changes a transporting direction of the recording medium to a direction vertical to the transporting direction.

### (2) The ink-jet recording apparatus as described in the item (1), wherein the light source of the active energy irradiating portion is positioned below a horizontal plane including the nozzle portion of the ink-jet head.

### (3) The ink-jet recording apparatus as described in the item (1), wherein the transporting direction changing portion comprises a roller.

### (4) The ink-jet recording apparatus as described in the item (3), wherein the roller is heated to from 40 to 150° C.

(5) The ink-jet recording apparatus as described in the item (1), which comprises a light-shielding cover extending between upstream and downstream transportation rollers, the light-shielding cover being disposed behind the active energy irradiating portion.

As described above, according to the invention as described in the item (1), the transporting direction of the recording medium can be changed by the transporting direction changing portion for changing the transporting direction of the recording medium to a direction vertical to the transporting direction, and hence the active energy irradiating portion can be shifted to a position which is remote from the ink-jet head.

According to the invention as described in the item (2), the light source of the active energy irradiating portion is positioned below a horizontal plane including the nozzle portion of the ink-jet head, and hence the amount of stray light which reaches the nozzle portion can be remarkably reduced.

According to the invention as described in the item (3), the transporting direction changing portion is a roller, and hence the recording medium can be transported at low friction without imposing undue force on the recording medium.

According to the invention as described in the item (4), the roller is heated to 40 to 150° C., and hence the fixing process can be performed also on the roller.

According to the invention as described in the item (5), the light-shielding cover having a length which extends between upstream and downstream transportation rollers is disposed behind the active energy irradiating portion, and hence the amount of stray light which reaches the nozzle portion can be further remarkably reduced.

In this way, stray light from the active-energy irradiating portion does not reach the nozzle portion of the adjacent ink-jet head, and hence the ink in the nozzle portion is not hardened. Therefore, it is possible to provide an ink-jet recording apparatus in which the productivity is high, recording can be performed on various recording media, and the life period is long.

### BRIEF DESCRIPTION OF THE DRAWINGS

The invention disclosed herein will be understood better with reference to the following drawings of which:

FIG. 1 is a diagram of an ink-jet recording apparatus which is Embodiment 1 of the invention;

FIG. 2 is a diagram of an ink-jet recording apparatus which is Embodiment 2 of the invention;

FIG. 3 is a diagram of conventional example 1 of an ink-jet recording apparatus; and

FIG. 4 is a diagram of conventional example 2 of an ink-jet recording apparatus.

### DETAILED DESCRIPTION OF THE INVENTION

### Embodiment 1

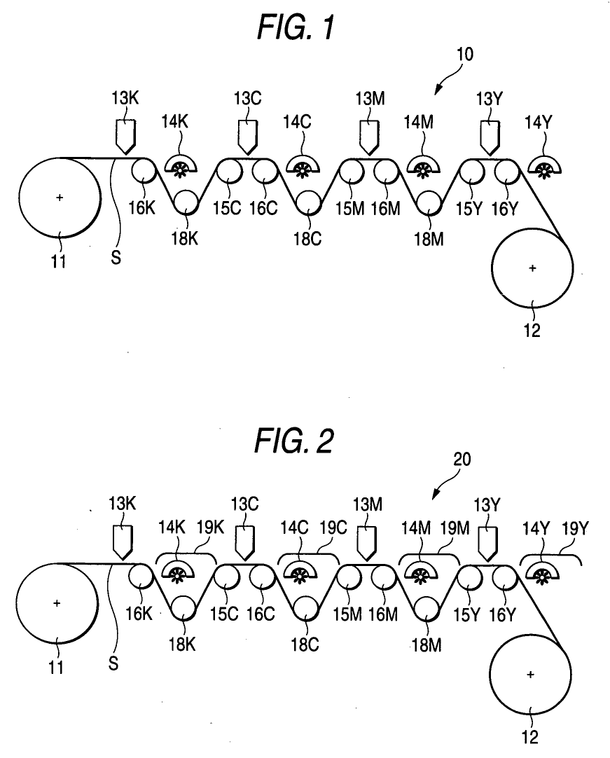

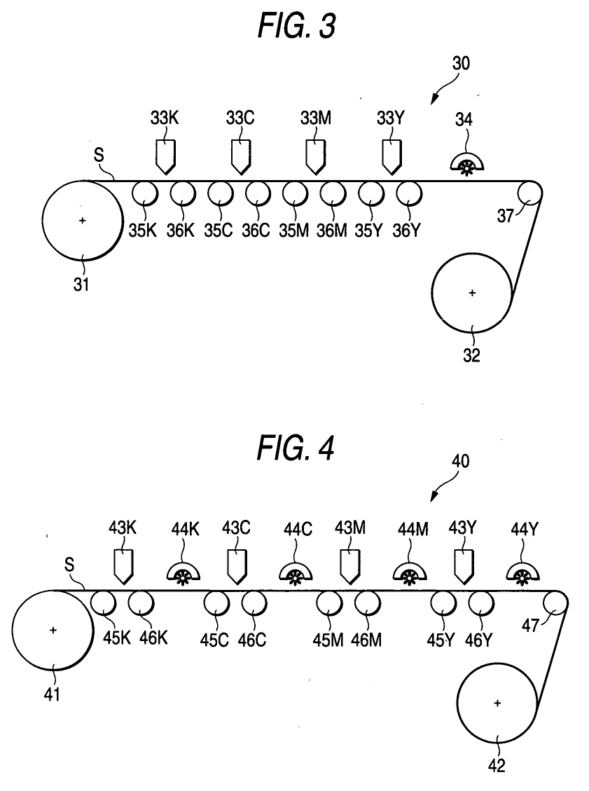

FIG. 1 is a diagram of an ink-jet recording apparatus (Hereinafter also simply referred to as an “active energy curable ink-jet recording apparatus”) which is Embodiment 1 of the invention. In the active energy curable ink-jet recording apparatus 10 shown in FIG. 1, a web-like recording medium S is taken out from a feed roller 11 around which the recording medium S is wound in a roll-like manner. During transportation under a K (black) color full-line head 13K in which many ink-jet nozzles are arranged in the width direction of the recording medium S, a K-color ink is recorded in an image-like manner onto the recording medium S. Immediately after the recording, the recording medium S is passed under active-energy irradiating portion 14K including an ultraviolet curing lamp (light source) to receive active energy rays, and the K-color ink is fixed.

In this case, according to the invention, between transporting portion 16K, 15C for the recording medium S, transporting direction changing portion 18K for changing the transporting direction of the recording medium S to a direction vertical to the transporting direction is disposed right by at least one of the upstream and downstream sides of the active energy irradiating portion 14K in the transporting direction of the recording medium S at a position between ink-jet heads 13k and 13C.

In FIG. 1, transportation rollers are arranged under the recording medium S, and a carry-in roller 15 and a carry-out roller 16 are provided for each of the full-line heads 13K to 13Y. With respect to the full-line head 13K, the feed roller 11 is used also as a substitute for the carry-in roller 15.

According to the configuration, light from the active-energy irradiating portion 14K advances in the downward direction in the figure, and, by contrast, the adjacent heads 13K, 13C are positioned higher than the active-energy irradiating portion 14K. Even when the light which has downward advanced is reflected or diffracted to be formed as stray light, therefore, the stray light hardly reaches the nozzle ports of the adjacent heads 13K, 13C which are in the upper side.

Accordingly, the ink in the nozzle portion is not hardened, and the recording apparatus is an apparatus in which the productivity is high, recording can be performed on various recording media, and the life period is long.

The subsequent ink-jet head 13C is configured in the sane manner. Namely, during transportation under a C-color full-line head 13C in which many ink-jet nozzles are arranged in the width direction of the recording medium S, then, a C-color ink is recorded in an image-like manner onto the recording medium S which has undergone the fixing process in the active-energy irradiating portion 14K. Immediately after the recording, the direction of the recording medium is changed so that the medium advances in the downward direction in the figure. Then, the recording medium is passed under active-energy irradiating portion 14C to receive active energy rays, and the C-color ink is fixed. In this case, the active-energy irradiating portion 14C is placed in a lower portion in the figure, and, by contrast, the adjacent heads 13C, 13M are positioned higher than the active-energy irradiating portion 14C. Even when the light which has downward advanced is reflected or diffracted to be formed as stray light, therefore, the stray light hardly reaches the nozzle ports of the adjacent heads 13C, 13M which are in the upper side, and the ink in the nozzle portion is not hardened.

The other ink-jet head 13M, 13Y are configured in the strictly same manner. Therefore, duplicated description will be omitted.

As the transporting direction changing portion, a direction changing bar or other direction changing portion may be used. When the transporting direction changing portion is realized by a direction changing roller 18K as shown in FIG. 1, undue stress is not applied to the transportation of the recording medium S. Therefore, the use of the direction changing roller 18K is preferable. Preferably, the direction changing roller has an easily peelable surface such as a surface formed by a fluorine resin. When the surface is configured as an easily peelable surface, the possibility that the ink adheres to the surface is reduced even when the intensity of the curing lamp is insufficient, or when there is a time lag in hardening of the ink.

When the direction changing roller is heated to 40 to 150° C., the fixing process can be performed also on the roller, and therefore fixation can be ensured. When the temperature is lower than 40° C., the fixing process does not advance, and, when the temperature is higher than 150° C., the recording medium S is damaged. Therefore, the temperature range should be kept.

### Embodiment 2

FIG. 2 is a diagram of an ink-jet recording apparatus which is Embodiment 2 of the invention. In the ink-jet recording apparatus 20 shown in FIG. 2, between transporting portion 16K, 15C for the recording medium S, transporting direction changing portion 18K for changing the transporting direction of the recording medium S to a direction vertical to the transporting direction is disposed in at least one of the immediately upstream and downstream sides of the active energy irradiating portion 14K in the transporting direction of the recording medium S (Embodiment 1). In Embodiment 2, in addition, a light-shielding cover 19K configured by a shade having a length which approximately extends between the transporting portion 16K, 15C is disposed behind the active energy irradiating portion 14K.

According to the configuration, even when light from the active energy irradiating portion 14K which has advanced in the downward direction in the figure is reflected or diffracted to be formed as stray light, and then returns to the upper side, the stray light is blocked by the light-shielding cover 19K. Therefore, the stray light never reaches the nozzle ports of the adjacent heads 13K, 13C which are in the upper side.

Accordingly, the ink in the nozzle portion is not hardened, and the recording apparatus is an apparatus in which the productivity is high, recording can be performed on various recording media, and the life period is long.

In the above, the light-shielding cover 19K has been described. The subsequent light-shielding covers 19C to 19Y are strictly identical in shape, function, and effect with the light-shielding cover 19K. Therefore, duplicated description will be omitted.

In the specification, the term “active energy rays” is not particularly restricted, and means any rays as far as, when an ink composition is irradiated with the rays, initiating species can be generated in the composition. For example, it includes a wide variety of rays such as a rays, y rays, X rays, ultraviolet rays, visible light rays, and electron beams. From the viewpoints of the curing sensitivity and availability of an apparatus, ultraviolet rays and electron beams are preferable. Particularly, ultraviolet rays are preferable. In the invention, therefore, it is preferable to use an ink composition which is curable by irradiation of ultraviolet rays.

In the ink-jet recording apparatus of the invention, although depending also on the absorption property of sensitizing dyes in the ink composition, the peak wavelength of the active energy rays is for example 200 to 600 nm, preferably, 300 to 450 nm, more preferably, 350 to 450 nm. In the invention, the electron transfer initiation system of the ink composition exhibits a sufficient sensitivity even in the case of a low output of active energy rays. Therefore, the output of active energy rays has irradiation energy which is for example 2,000 mJ/cm² or less, preferably, 10 to 2,000 mJ/cm², more preferably, 20 to 1,000 mJ/cm², further preferably, 50 to 800 mJ/cm². The irradiation of the active energy rays is performed at the exposure face illuminance (the maximum illuminance of the surface of the recording medium) is for example 10 to 2,000 mW/cm², preferably, 20 to 1,000 mW/cm².

In the ink-jet recording apparatus of the invention, particularly, it is preferable that the irradiation of the active energy rays is performed by a light emitting diode generating ultraviolet rays in which the peak emission wavelength is 390 to 420 nm, and the maximum illuminance of the surface of the recording medium is 10 to 1,000 mW/cm².

In the ink-jet recording apparatus of the invention, the ink composition ejected onto the recording medium is irradiated with active energy rays for, for example, 0.01 to 120 sec., preferably, 0.1 to 90 sec.

In the ink-jet recording apparatus of the invention, preferably, the ink composition is heated to a constant temperature, and the time period from the impact of the ink composition onto the recording medium to the irradiation of active energy rays is 0.01 to 0.5 sec., preferably, 0.02 to 0.3 sec., more preferably, 0.03 to 0.15 sec. When the time period from the impact of the ink composition onto the recording medium to the irradiation of active energy rays is controlled so as to be very short in this way, it is possible to prevent the impacted ink composition from blurring before the ink composition cures.

When a color image is to be obtained by using the ink-jet recording apparatus of the invention, preferably, colors are sequentially stacked in ascending order of luminosity. When colors are stacked in this manner, the active energy rays easily reaches even a lower ink, and an excellent curing sensitivity, reduction of residual monomers, reduction of odor, and improvement of adherence can be expected. In irradiation of active energy rays, it is possible to emit all colors to collectively perform the exposure. From the viewpoint of promotion of curing, however, it is preferable to perform the exposure on each color.

For example, the ink-jet head in the invention is a piezoelectric ink-jet head, and may be driven so as to emit multi-size dots of 1 to 100 pl, preferably, 1 to 30 pl at a resolution of 320×320 to 4,000×4,000 dpi, preferably, 400×400 to 2,400×2,400 dpi. In the specification, “dpi” means the number of dots per 2.54 cm.

As described above, in an active energy rays curable ink such as the ink composition in the invention, the ejected ink composition is preferably set to a constant temperature. In a range from an ink supply cartridge to an ink-jet head portion, therefore, it is preferable to perform a temperature control due to heat insulation and heating. In order to prevent the main unit of the apparatus from being affected by the temperature of the atmosphere, preferably, a head unit in which heating is performed is thermally isolated or heat-insulated. In order to shorten the start-up time of a printer required for heating, or reduce the loss of heat energy, preferably, the heating unit is heat-insulated from the other units, and the thermal capacity of the whole heating unit is reduced.

As the source of active energy rays, a mercury lamp, a gas/solid state laser, or the like is mainly used. In an ultraviolet curable ink-jet recording apparatus, a mercury lamp or a metal halide lamp is widely used. The replacement to a GaN semiconductor ultraviolet light emitting device is very effective from industrial and environmental viewpoints. Furthermore, an LED (UV-LED) and an LD (UV-LD) have features of a small size, a long life period, a high efficiency, and a low cost, and hence are expected as a radiation source for an active energy rays curable ink-jet recording apparatus.

As described above, a light emitting diode (LED) or a laser diode (LD) can be used as the source of active energy rays. In the case where an ultraviolet ray source is required, particularly, an ultraviolet LED or an ultraviolet LD can be used. For example, Nichia Corporation has marketed a violet LED in which the main emission spectrum is a wavelength between 365 nm and 420 nm. In the case where a shorter wavelength is necessary, U.S. Pat. No. 6,084,250 discloses an LED which can emit active energy rays centered between 300 nm and 370 nm. Other ultraviolet LEDs are also available, so that radiation of a different ultraviolet ray band is possible. In the invention, a preferable active energy source is an UV-LED, and a particularly preferable source is an UV-LED having a peak wavelength at 350 to 420 nm.

### (Medium to be Recorded)

The medium to be recorded to which the ink composition of the invention is applicable is not particularly limited, and useful examples thereof include papers such as usual non-coated papers and coated papers and various non-absorbing resin materials which are used for so-called flexible packaging or resin films resulting from molding such a resin material into a film. Examples of various plastic films which can be used include PET films, OPS films, OPP films, ONy films, PVC films, PE films, and TAC films. Besides, examples of plastics which can be used as the medium to be recorded include polycarbonates, acrylic resins, ABS, polyacetals, PVA, and rubbers. Metals and glasses can also be used as the medium to be recorded.

In the ink composition of the invention, in the case where a material which is low in heat shrinkage at the time of curing is selected, it is excellent in adhesion between the cured ink composition and the medium to be recorded. Thus, there is an advantage that a high-definition image can be formed even by using a film which is liable to cause curling or deformation due to curing and shrinkage of the ink or the heat generation at the time of curing reaction, such as PET films, OPS films, OPP films, ONy films, and PVC films, all of which are shrinkable by heat.

The respective constitutional components to be used in the ink composition which can be used in the invention will be hereunder described in order.

### (Ink Composition)

The ink composition which is used in the invention is an ink composition which is curable by irradiation with active energy rays, and examples thereof include a cationic polymerization based ink composition, a radical polymerization based ink composition, and an aqueous ink composition. These compositions will be hereunder described in detail.

### (Cationic Polymerization Ink Composition)

The cationic polymerization ink composition contains (a) a cationic polymerizable compound, (b) a compound from which an acid is produced by irradiation of active energy rays, and (c) a colorant. As desired, the composition may contain an ultraviolet absorber, a sensitizer, an antioxidizing agent, a discoloration preventing agent, conductive salts, a solvent, a polymer compound, a surfactant, etc.

Hereinafter, components used in the cationic polymerization ink composition will be sequentially described.

(a) Cationic Polymerizable Compound:

In the invention, (a) the cationic polymerizable compound is not particularly restricted, and any compound may be useful as far as it causes a polymerization reaction with an acid originated from (b) the compound from which the acid is produced by irradiation of active energy rays, and is cured. Various known cationic polymerizable monomers which are known as light cationic polymerizable monomers may be used. Examples of a cationic polymerizable monomer are an epoxy compound, a vinyl ether compound, an oxetane compound, and the like disclosed in various publications such as JP-A-6-9714, JP-A-2001-31892, JP-A-2001-40068, JP-A-2001-55507, JP-A-2001-310938, JP-A-2001-310937, and JP-A-2001-220526.

Examples of the epoxy compound include aromatic epoxides, alicyclic epoxides, and aliphatic epoxides.

As the aromatic epoxide, there are enumerated di- or polyglycidyl ethers resulting from a reaction of a polyhydric phenol having at least one aromatic nucleus or an alkylene oxide adduct thereof with epichlorohydrin. Examples thereof include di- or polyglycidyl ethers of bisphenol A or an alkylene oxide adduct thereof, di- or polyglycidyl ethers of hydrogenated bisphenol A or an alkylene oxide adduct, and novolak type epoxy resins. Here, examples of the alkylene oxide include ethylene oxide and propylene oxide.

As the alicyclic epoxide, there are preferably enumerated cyclohexene oxide-containing or cyclopentene oxide-containing compounds which are obtained by epoxidizing a compound having at least one cycloalkene ring such as a cyclohexene ring and a cyclopentene ring with a suitable oxidizing agent such as hydrogen peroxide and peracids.

As the aliphatic epoxide, there are enumerated di- or polyglycidyl ethers of an aliphatic polyhydric alcohol or an alkylene oxide adduct thereof. Representative examples thereof include diglycidyl ethers of an alkylene glycol such as diglycidyl ether of ethylene oxide, diglycidyl ether of propylene glycol, and diglycidyl ether of 1,6-hexanediol; polyglycidyl ethers of a polyhydric alcohol such as di- or triglycidyl ethers of glycerin or an alkylene oxide adduct thereof; and diglycidyl ethers of a polyalkylene glycol represented by diglycidyl ethers of polyethylene glycol or an alkylene oxide adduct thereof and diglycidyl ethers of polypropylene glycol or an alkylene oxide adduct thereof. Here, examples of the alkylene oxide include ethylene oxide and propylene oxide.

The epoxy compound may be monofunctional or polyfunctional.

Examples of the monofunctional epoxy compound which can be used in the invention include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadienemonoxide, 1,2-epoxydodecane, epichlorohydrin, 1,2-epoxydecane, styrene oxide, cyclohexene oxide, 3-methacryloyloxymethylcyclohexene oxide, 3-ac-ryloyloxymethylcyclohexene oxide, and 3-vinylcyclohexene oxide.

Furthermore, examples of the polyfunctional epoxy compound include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolak resins, hydrogenated bisphenol A diglycidyl ether, hydrogenated bisphenol F diglycidyl ether, hydrogenated bisphenol S diglycidyl ether, 3,4-epoxycyclo-hexylmethyl-3′,4′-epoxycyclohexane carboxylate, 2-(3,4-epoxy-cyclohexyl-5,5-spiro-3,4-epoxy)cyclohexane-m-dioxane, bis-(3,4-epoxycyclohexylmethyl) adipate, vinylcyclohexene oxide, 4-vinylepoxycyclohexane, bis(3,4-epoxy-6-methylcyclohexyl-methyl) adipate, 3,4-epoxy-6-methylcyclohexyl-3′,4′-epox-y-6′-methylcyclohexane carboxylate, methylenebis(3,4-e-poxycyclohexane), dicyclopentadiene diepoxide, di(3,4-e-poxycyclohexylmethyl) ether of ethylene glycol, ethylene-bis(3,4-epoxycyclohexane carboxylate), dioctyl epoxy-hexahydrophthalate, di-2-ethylhexyl epoxyhexahydrophthalate, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ethers, 1,1,3-tetradecadiene dioxide, limonene dioxide, 1,2,7,8-diepoxyoctane, and 1,2,5,6-diepoxycyclooctane.

Of these epoxy compounds, from the viewpoint of excellent curing rate, aromatic epoxides and alicyclic epoxides are preferable; and alicyclic epoxides are especially preferable.

Examples of the vinyl ether compound include di- or trivinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether; and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-O-propylene carbonate, dodecyl vinyl ether, diethylene glycol monovinyl ether, and octadecyl vinyl ether.

The vinyl ether compound may be monofunctional or poly-functional.

Concretely, examples of the monofunctional vinyl ether include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether.

Furthermore, examples of the polyfunctional vinyl ether include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ethers, and bisphenol F alkylene oxide divinyl ethers; and polyfunctional vinyl ethers such as trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, dipentaerythritol hexavinyl ether, ethylene oxide-added trimethylolpropane trivinyl ether, propylene oxide-added trimethylolpropane trivinyl ether, ethylene oxide-added ditrimethylolpropane tetravinyl ether, propylene oxide-added ditrimethylolpropane tetravinyl ether, ethylene oxide-added pentaerythritol tetravinyl ether, propylene oxide-added pentaerythritol tetravinyl ether, ethylene oxide-added dipentaerythritol hexavinyl ether, and propylene oxide-added dipentaerythritol hexavinyl ether.

As the vinyl ether compound, from the viewpoints of curing properties, adhesion to the medium to be recorded and surface hardness of the formed image, di- or trivinyl ether compounds are preferable; and divinyl ether compounds are especially preferable.

The oxetane compound as referred to in the invention means a compound having an oxetane ring and can be arbitrarily selected and used among known oxetane compounds as described in JP-A-2001-220526, JP-A-2001-310937, and JP-A-2003-341217.

As the compound having an oxetane ring which can be used in the ink composition of the invention, compounds having from one to four oxetane rings in the structure thereof are preferable. By using such a compound, it becomes easy to keep the ink composition so as tomake aviscosity fall within the range suitable for handling properties. Furthermore, it is possible to obtain high adhesion between the ink composition and the medium to be recorded after curing.

Such a compound having an oxetane ring is described in detail in paragraphs [0021] to [0084] of JP-A-2003-341217, and compounds as described in this patent document can also be suitably used in the invention.

Of the oxetane compounds which are used in the invention, it is preferred to use a compound having one oxetane ring from the viewpoints of viscosity and adhesiveness of the ink composition.

In the ink composition of the invention, such a cationic polymerizable compound may be used singly or in combination of two or more kinds thereof. However, from the viewpoint of the matter that shrinkage at the time of curing of the ink is effectively controlled, it is preferred to use a combination of at least one compound selected from oxetane compounds and epoxy compounds with a vinyl ether compound.

The content of the cationic polymerizable compound (a) in the ink composition is suitably in the range of from 10 to 95% by weight, preferably from 30 to 90% by weight, and more preferably from 50 to 85% by weight with respect to the whole of solids of the composition.

(b) Compound Capable of Generating an Acid by Irradiation with Active Energy Rays:

The ink composition of the invention contains a compound capable of generating an acid by irradiation with active energy rays (hereinafter properly referred to as “photo acid generating agent”).

As the photo acid generating agent which can be used in the invention, compounds capable of generating an acid by irradiation of rays (for example, ultraviolet rays and far ultraviolet rays having a wavelength of from 400 to 200 nm; especially preferably g-rays, h-rays, i-rays, and KrF excimer lasers), ArF excimer lasers, electron beams, X-rays, molecular rays, or ion beams, which are used in photo cationic polymerization photoinitiators, photo radical polymerization photoinitiators, photo decolorizing agents of dyes, photo discoloring agents, or micro resists, can be properly selected and used.

Examples of such a photo acid generating agent include compounds which are decomposed by irradiation with active energy rays to generate an acid such as onium salts (for example, diazonium salts, ammonium salts, phosphonium salts, iodonium salts, sulfonium salts, selenonium salts, and arsonium salts), organic halogen compounds, organic metals or organic halides, photo acid generating agents having an o-nitrobenzyl type protective group, compounds which are photo decomposed to generate sulfonic acid, represented by imino sulfonate, disulfone compounds, diazo keto sulfone, and diazo disulfone compounds.

Also, oxazole derivatives and s-triazine derivatives as described in paragraphs [0029] to [0030] of JP-A-2002-122994 can be suitably used as the photo acid generating agent. In addition, onium salt compounds and sulfonate based compounds as enumerated in paragraphs [0037] to [0063] of JP-A-2002-122994 can be suitably used as the photo acid generating agent in the invention.

The photo acid generating agent (b) can be used singly or in combination with two or more kinds thereof.

The content of the photo acid generating agent (b) in the ink composition is preferably from 0.1 to 20% by weight, more preferably from 0.5 to 10% by weight, and further preferably from 1 to 7% by weight with respect to the whole of solids of the ink composition.

(c) Coloring Agent:

In the ink composition of the invention, by adding a coloring agent, it is possible to form a visible image. For example, in the case of forming an image area region of a lithographic printing plate, though it is not always required to add a coloring agent, it is preferred to use a coloring agent from the viewpoint of plate inspection properties of the resulting lithographic printing plate.

The coloring agent which can be used herein is not particularly limited but can be properly selected and used among various known coloring materials (for example, pigments and dyes) depending upon the utilization. For example, in the case of forming an image having excellent weather resistance, a pigment is preferable. As the dye, though any of water-soluble dyes and oil-soluble dyes can be used, oil-soluble dyes are preferable.

### (Pigment)

The pigment which is preferably used in the invention will be hereunder described.

The pigment is not particularly limited. For example, all organic pigments and inorganic pigments which are generally commercially available, substances resulting from dispersing a pigment in, as a dispersion medium, an insoluble resin, etc., and substances resulting from grafting a resin on the surface of a pigment can be used. Substances resulting from dyeing a resin particle with a dye can also be used.

Examples of such a pigment include pigments as described in Ganryo No Jiten (Pigment Dictionary), edited by Seishiro ITO (published in 2000), W. Herbst and K. Hunger, Industrial Organic Pigments, JP-A-2002-12607, JP-A-2002-188025, JP-A-2003-26978, and JP-A-2003-342503.

Specific examples of the organic pigment and the inorganic pigment which can be used in the invention are as follows. That is, examples of pigments which exhibit a yellow color include monoazo pigments such as C.I. Pigment Yellow 1 (for example, Fast Yellow G) and C.I. Pigment Yellow 74; disazo pigments such as C.I. Pigment Yellow 12 (for example, Disazo Yellow AAA) and C.I. Pigment Yellow 17; non-benzidine based azo pigments such as C.I. Pigment Yellow 180; azo lake pigments such as C.I. Pigment Yellow 100 (for example, Tartrazine Yellow Lake); condensed azo pigments such as C.I. Pigment Yellow 95 (for example, Condensed Azo Yellow GR); acid dye lake pigments such as C.I. Pigment Yellow 115 (for example, Quinoline Yellow Lake); basic dye lake pigments such as C.I. Pigment Yellow 18 (for example, Thiof lavine Lake); anthraquinone based pigments such as Flavanthrone Yellow (Y-24); isoindolinone pigments such as Isoindolinone Yellow 3RLT (Y-110); quinophthalone pigments such as Quinophthalone Yellow (Y-138); isoindoline pigments such as Isoindoline Yellow (Y-139); nitrosopigments such as C.I. Pigment Yellow 153 (for example, Nickel Nitroso Yellow); and metal complex salt azomethine pigments such as C.I. Pigment Yellow 117 (for example, Copper Azomethine Yellow).

Examples of pigments which exhibit a red or magenta color include monoazo based pigments such as C.I. Pigment Red 3 (for example, Toluidine Red); disazo pigments such as C.I. Pigment Red 38 (for example, Pyrazolone Red B); azo lake pigments such as C.I. Pigment Red 53:1 (for example, Lake Red C) and C.I. Pigment Red 57:1 (for example, Brilliant Carmine 6B); condensed azo pigments such as C.I. Pigment Red 144 (for example, Condensed Azo Lake BR); acid dye lake pigments such as C.I. Pigment Red 174 (for example, Phloxine B Lake); basic dye lake pigments such as C.I. Pigment Red 81 (for example, Rhodamine 6G′ Lake); anthraquinone based pigments such as C.I. Pigment Red 177 (for example Dianthraquinonyl Red); thioindigo pigments such as C.I. Pigment Red 88 (for example, Thioindigo Bordeaux); perinone pigments such as C.I. Pigment Red 194 (for example, Perinone Red); perylene pigments such as C.I. Pigment Red 149 (for example, Perylene Scarlet); quinacridone pigments such as C.I. Pigment Violet 19 (for example, unsubstituted quinacridone) and C.I. Pigment Red 122 (for example, Quinacridone Magenta); isoindolinone pigments such as C.I. Pigment Red 180 (for example, Isoindolinone Red 2BLT); and alizarine lake pigments such as C.I. Pigment Red 83 (for example, Madder Lake).

Examples of pigments which exhibit a blue or cyan color include disazo based pigments such as C.I. Pigment Blue 25 (for example, Dianisidine Blue); phthalocyanine pigments such as C.I. Pigment Blue 15 (for example, Phthalocyanine Blue); acid dye lake pigments such as C.I. Pigment Blue 24 (for example, Peacock Blue Lake); basic dye lake pigments such as C.I. Pigment Blue 1 (for example, Victoria Pure Blue BO Lake); anthraquinone based pigments such as C.I. Pigment Blue 60 (for example, Indanthrone Blue); and alkali blue pigments such as C.I. Pigment Blue 18 (for example, Alkali Blue V-5:1).

Examples of pigments which exhibit a green color include phthalocyanine pigments such as C.I. Pigment Green 7 (Phthalocyanine Green) and C.I. Pigment Green 36 (Phthalocyanine Green) ; and azo metal complex pigments such as C.I. Pigment Green 8 (Nitroso Green).

Examples of pigments which exhibit an orange color include isoindoline based pigments such as C.I. Pigment Orange 66 (Isoindoline Orange); and anthraquinone based pigments such as C. I. Pigment Orange 51 (Dichloropyranthrone Orange).

Examples of pigments which exhibit a black color include carbon black, titanium black, and aniline black.

Specific examples of white pigments which can be used include basic lead carbonate (2PbCO₃Pb(OH)₂, so-called “silver white”), zinc oxide (ZnO, so-called “zinc white”), titanium oxide (TiO₂, so-called “titanium white”), strontium titanate (SrTiO₃, so-called “titanium strontium white”).

Here, titanium oxide has a low specific gravity and a high refractive index and is chemically and physically stable as compared with other white pigments. Thus, the titanium oxide has large covering power and coloring power as a pigment and has excellent durability against acids, alkalis and other environments. Accordingly, it is preferred to use titanium oxide as the white pigment. As a matter of course, other white pigments (other white pigments than those as enumerated previously may also be used) may be used as the need arises.

For dispersing the pigment, dispersing units such as a ball mill, a sandmill, anattritor, a roll mill, a jet mill, ahomogenizer, a paint shaker, a kneader, an agitator, a Henschel mixer, a colloid mill, an ultrasonic homogenizer, a pearl mill, and a wet jet mill can be employed.

In dispersing the pigment, it is also possible to add a dispersant. Examples of the dispersant include hydroxyl group-containing carboxylic acid esters, salts between a long chain polyaminoamide and a high molecular acid ester, salts of a high molecular polycarboxylic acid, high molecular unsaturated acid esters, high molecular copolymers, modified polyacrylates, aliphatic polyhydric carboxylic acids, naphthalenesulfonic acid formalin condensates, polyoxyethylene alkylphosphoric esters, and pigment derivatives. It is also preferred to use a commercially available high molecular dispersant such as Zeneca's SOLSPERSE Series.

Furthermore, it is possible to use, as a dispersing agent, a synergist adaptive to a pigment of every kind. It is preferable that such a dispersant or dispersing agent is added in an amount of from 1 to 50 parts by weight based on 100 parts by weight of the pigment.

In the ink composition, a solvent may be added as a dispersion medium for various components inclusive of the pigment. Also, the foregoing cationic polymerizable compound (a) which is a low molecular component may be used as the dispersion medium in the absence of a solvent. However, since the ink composition of the invention is an active energy rays curing type ink and after applying on the medium to be recorded, the ink is cured, it is preferred that the ink composition is free from a solvent. This is because when the solvent remains in the cured ink image, the solvent resistance is deteriorated or the residual solvent causes a problem of VOC (volatile organic compound). In view of the foregoing, what the cationic polymerizable compound (a) is used as the dispersion medium, especially a cationic polymerizable monomer having the lowest viscosity is selected is preferable from the viewpoints of dispersing adaptability and improvement of handling properties of the ink composition.

An average particle size of the pigment is preferably in the range of from 0.02 to 4 μm, more preferably from 0.02 to 2 μm, and further preferably from 0.02 to 1.0 μm.

In order to make the average particle size of the pigment particle fall within the foregoing preferred range, the pigment, the dispersant and the dispersion medium are selected, and the dispersing condition and the filtration condition are set up. By managing the particle size, it is possible to control plugging of a head nozzle and to keep the storage stability of the ink and the transparency and curing sensitivity of the ink.

### (Dye)

As the dye which is used in the invention, an oil-soluble dye is preferable. Concretely, the oil-soluble dye is a dye having a solubility in water at 25° C. (weight of the dye which is dissolved in 100 g of water) of not more than 1 g, preferably not more than 0.5 g, and more preferably not more than 0.1 g. Accordingly, a so-called water-insoluble and oil-soluble dye is preferably used.

In the dye which is used in the invention, it is also preferred to introduce an oil-solubilizing group into the mother nucleus of the foregoing dye for the purpose of dissolving a necessary amount of the dye in the ink composition.

Examples of the oil-solubilizing group include a long chain or branched alkyl group, a long chain or branched alkoxy group, a long chain or branched alkylthio group, a long chain or branched alkylsulfonyl group, a long chain or branched acyloxy group, a long chain or branched alkoxycarbonyl group, a long chain or branched acyl group, a long chain or branched acylamino group, a long chain or branched alkylsulfonylamino group, and a long chain or branched alkylaminosulfonyl group; and an aryl group, an aryloxy group, an aryloxycarbonyl group, an arylcarbonyloxy group, an arylaminocarbonyl group, an arylaminosulfonyl group, and an arylsulfonylamino group each containing the foregoing long chain or branched substituent.

Furthermore, with respect to the water-soluble dye having a carboxyl acid or a sulfonic acid, a dye may be obtained by converting it into an oil-solubilizing group including an alkoxycarbonyl group, an aryloxycarbonyl group, an alkylaminosulfonyl group, and an arylaminosulfonyl group using a long chain or branched alcohol, amine, phenol or aniline derivative.

The oil-soluble dye is preferably an oil-soluble dye having a melting point of not higher than 200° C., more preferably an oil-soluble dye having a melting point of not higher than 150° C., and further preferably an oil-soluble dye having a melting point of not higher than 100° C. By using an oil-soluble dye having a low melting point, deposition of a crystal of the dye in the ink composition is controlled, and the storage stability of the ink composition is improved.

Furthermore, for the purpose of improving fading, especially resistance to oxidizers such as ozone and curing characteristics, it is preferable that the oxidation potential is noble (high). For that reason, an oil-soluble dye having an oxidation potential of 1.0 V (vs SCE) or more is preferably used as the oil-soluble dye to be used in the invention. It is preferable that the oxidation potential is higher. The oxidation potential is more preferably 1.1 V (vs SCE) or more, and especially preferably 1.15 V (vs SCE) or more.

As a dye having a yellow color, compounds having a structure represented by the general formula (Y-I) as described in JP-A-2004-250483 are preferable.

Dyes represented by the general formulae (Y-II) to (Y-IV) as described in paragraph [0034] of JP-A-2004-250483 are especially preferable. Specific examples thereof include compounds as described in paragraphs [0060] to [0071] of JP-A-2004-250483. Incidentally, the oil-soluble dyes of the general formula (Y-I) as described in the subject patent document may be used for inks of any colors including not only yellow inks but also black inks and red inks.

As a dye having a magenta color, compounds having a structure represented by the general formulae (3) and (4) as described in JP-A-2002-114930 are preferable. Specific examples thereof include compounds as described in paragraphs [0054] to [0073] of JP-A-2002-114930.

Azo dyes represented by the general formulae (M-1) to (M-2) as described in paragraphs [0084] to [0122] of JP-A-2002-121414 are especially preferable. Specific examples thereof include compounds as described in paragraphs [0123] to [0132] of JP-A-2002-121414. Incidentally, the oil-soluble dyes of the general formulae (3), (4) and (M-1) to (M-2) as described in the subject patent document may be used for inks of any colors including not only magenta inks but also black inks and red inks.

As a dye having a cyan color, dyes represented by the general formulae (I) to (IV) as described in JP-A-2001-181547 and dyes represented by the general formulae (IV-1) to (IV-4) as described in paragraphs [0063] to [0078] of JP-A-2002-121414 are preferable. Specific examples thereof include compounds as described in paragraphs [0052] to [0066] of JP-A-2001-181547 and compounds as described in paragraphs [0079] to [0081] of JP-A-2002-121414.

Phthalocyanine dyes represented by the general formulae (C-I) and (C-II) as described in paragraphs [0133] to [0196] of JP-A-2002-121414 are especially preferable, with phthalocyanine dues represented by the general formula (C-II) being further preferable. Specific examples thereof include compounds as described in paragraphs [0198] to [0201] of JP-A-2002-121414. Incidentally, the oil-soluble dyes of the foregoing general formulae (I) to (IV), (IV-1) to (IV-4), (C-I) and (C-II) may be used for inks of any colors including not only cyan inks but also black inks and green inks.

Such a coloring agent is preferably added in an amount of from 1 to 20% by weight, and more preferably from 2 to 10% by weight with respect to the whole of solids in the ink composition.

### (Other Components)

Various additives which are used depending upon the situation will be hereunder described.

### (Ultraviolet Ray Absorber)

In the invention, an ultraviolet ray absorber can be used from the viewpoints of improving the weather resistance and preventing the fading on the resulting image.

Examples of the ultraviolet ray absorber include benzotriazole based compounds described in JP-A-58-185677, JP-A-61-190537, JP-A-2-782, JP-A-5-197075, and JP-A-9-34057; benzophenone based compounds as described in JP-A-46-2784, JP-A-5-194483, and U.S. Pat. No. 3,214,463; cinnamic acid based compounds as described in JP-B-48-303492, JP-B-56-21141, and JP-A-10-88106; triazine based compounds as described in JP-A-4-298503, JP-A-8-53427, JP-A-8-239368, JP-A-10-182621, and JP-T-8-501291; compounds as described in Research Disclosure, No. 24239; compounds capable of absorbing ultraviolet rays to emit fluorescence, as represented by stilbene based compounds and benzoxazole based compounds; and so-called fluorescent brighteners.

Though the amount of addition of the ultraviolet ray absorber is properly selected depending upon the purpose, it is generally from about 0.5 to 15% by weight as calculated as solids.

### (Sensitizer)

For the purposes of improving the acid generation efficiency of the photo acid generating agent and shifting the light-sensitive wavelength into a long wavelength side, a sensitizer may be added in the ink composition of the invention as the need arises. The sensitizer may be any sensitizer so far as it is able to sensitize the photo acid generating agent through an electron transfer mechanism or an energy transfer mechanism. Preferred examples thereof include aromatic polyfused compounds such as anthracene, 9,10-dialkoxyanthracenes, pyrene, and perylene; aromatic ketone compounds such as acetophenone, benzophenone, thioxanthone, and Michler's ketone; and heterocyclic compounds such as phenothiazine and N-aryloxazolidinones. Though the amount of addition of the sensitizer is properly selected depending upon the purpose, it is generally from 0.01 to 1% by mole, and preferably from 0.1 to 0.5% by mole with respect to the photo acid generating agent.

### (Antioxidant)

For the purpose of improving the stability of the ink composition, an antioxidant can be added. Examples of the antioxidant include antioxidants as described in EP-A-223739, EP-A-309401, EP-A-309402, EP-A-310551, EP-A-310552, EP-A-459416, DE-A-3435443, JP-A-54-48535, JP-A-62-262047, JP-A-63-113536, JP-A-63-163351, JP-A-2-262654, JP-A-2-71262, JP-A-3-121449, JP-A-5-61166, JP-A-5-119449, and U.S. Pat. Nos. 4,814,262 and 4,980,275.

Though the amount of addition of the antioxidant is properly selected depending upon the purpose, it is generally from about 0.1 to 8% by weight as calculated as solids.

### (Anti-Fading Agent)

In the ink composition of the invention, various organic or metal complex based anti-fading agents can be used. Examples of the organic anti-fading agent include hydroquinones, alkoxyphenols, dialkoxyphenols, phenols, anilines, amines, indanes, chromans, alkoxyanilines, and heterocyclic compounds. Examples of the metal complex based anti-fading agent include nickel complexes and zinc complexes. Concretely, compounds described in patents as cited in Research Disclosure, No. 17643, No. VII, Items I to J, ibid., No. 15162, ibid., No. 18716, page 650, left-hand column, ibid., No. 36544, page 527, ibid., No. 307105, page 872, and ibid., No. 15162; and compounds included in the general formulae of representative compounds and compound examples as describe on pages 127 to 137 of JP-A-62-215272 can be used.

Though the amount of addition of the anti-fading agent is properly selected depending upon the purpose, it is generally from about 0.1 to 8% by weight as calculated as solids.

### (Conductive Salt)

For the purpose of controlling injection physical properties, conductive salts such as potassium thiocyanate, lithium nitrate, ammonium thiocyanate, and dimethylamine hydrochloride can be added in the ink composition of the invention.

### (Solvent)

In the ink composition of the invention, for the purpose of improving adhesion to the medium to be recorded, it is also effective to add an extremely trace amount of an organic solvent.

Examples of the solvent include ketone based solvents such as acetone, methyl ethyl ketone, and diethyl ketone; alcohol based solvents such as methanol, ethanol, 2-propanol, 1-propanol, 1-butanol, and tert-butanol; chlorine based solvents such as chloroform and methylene chloride; aromatic solvents such as benzene and toluene; ester based solvents such as ethyl acetate, butyl acetate, and isopropyl acetate; ether based solvents such as diethyl ether, tetrahydrofuran, and dioxane; and glycol ether based solvents such as ethylene glycol monomethyl ether and ethylene glycol dimethyl ether.

In this case, it is effective to add the solvent in an amount within the range where problems in solvent resistance and VOC are not caused. Its amount is preferably in the range of from 0.1 to 5% by weight, and more preferably from 0.1 to 3% by weight with respect to the whole of the ink composition.

### (High Molecular Compound)

For the purpose of adjusting film physical properties, various high molecular compounds can be added in the ink composition of the invention. Examples of the high molecular compound which can be used include acrylic polymers, polyvinyl butyral resins, polyurethane resins, polyamide resins, polyester resins, epoxy resins, phenol resins, polycarbonate resins, polyvinyl butyral resins, polyvinyl formal resins, shellac, vinyl based resins, acrylic resins, rubber based resins, waxes, and other natural resins. Such a high molecular compound may be used in combination with two or more kinds thereof. Of these, vinyl based copolymers obtainable from copolymerization of an acrylic monomer are preferable. In addition, with respect to the copolymerization composition of a high molecular binding material, copolymers containing, as a structural unit, a “carboxyl group-containing monomer”, an “alkyl methacrylate” or an “alkyl acrylate” are also preferably used.

### (Surfactant)

A surfactant may also be added in the ink composition of the invention.

As the surfactant, there are enumerated surfactants as described in JP-A-62-173463 and JP-A-62-183457. Examples thereof include anionic surfactants such as dialkylsulfosuccinic acid salts, alkylnaphthalenesulfonic acid salts, and fatty acid salts; nonionic surfactants such as polyoxyethylene alkyl ethers, polyoxyethylene alkylaryl ethers, acetylene glycols, and polyoxyethylene-polyoxypropylene block copolymers; and cationic surfactants such as alkylamine salts and quaternary ammonium salts. Incidentally, organic fluoro compounds may be used in place of the foregoing surfactants. It is preferable that the organic fluoro compound is hydrophobic. Examples of the organic fluoro compound include fluorine based surfactants, oily fluorine based compounds (for example, fluorine oils), and solid fluorine compound resins (for example, tetrafluoroethylene resins). Also, there are enumerated organic fluoro compounds as described in JP-B-57-9053 (columns 8 to 17) and JP-A-62-135826.

Besides, it is possible to contain, for example, a leveling additive, a matting agent, a wax for adjusting film physical properties, and a tackifier for improving adhesion to a medium to be recorded such as polyolef ins and PET, which does not hinder the polymerization, as the need arises.

Concretely, the tackifier includes high molecular adhesive polymers as describedonpages 5 to 6 of JP-A-2001-49200 (for example, copolymers made of an ester between (meth)acrylic acid and an alcohol containing an alkyl group having from 1 to 20 carbon atoms, an ester between (meth)acrylic acid and an alicyclic alcohol having from 3 to 14 carbon atoms, or an ester between (meth)acrylic acid and an aromatic alcohol having from 6 to 14 carbon atoms); and low molecular tackiness-imparting resins containing a polymerizable unsaturated bond.

### (Preferred Physical Properties of Ink Composition)

Taking into account the injection properties, an ink viscosity of the ink composition of the invention is preferably not more than 20 mpa·s, and more preferably not more than 10 mPa·s at the temperature at the time of injection. Furthermore, it is preferable that a composition ratio is properly adjusted and determined such that the ink viscosity falls within the foregoing range.

A surface tension of the ink composition of the invention is preferably from 20 to 30 mN/m, and more preferably from 23 to 28 mN/m. In the case of achieving recording on various media to be recorded such as polyolefins, PET, coated papers, and non-coated papers, the surface tension of the ink composition of the invention is preferably 20 mN/m or more from the viewpoints of oozing and penetration, and it is preferably not more than 30 mN/m in view of wetting properties.

The thus adjusted ink composition of the invention is suitably used as an ink for inkjet recording. In the case of using the ink composition of the invention as an ink for inkjet recording, the ink composition is injected onto a medium to be recorded by an inkjet printer, and thereafter, the injected ink composition is irradiated with active energy rays and cured, thereby achieving recording.

Since a printed matter as obtained from this ink has an image area which has been cured by irradiation with active energy rays such as ultraviolet rays and has excellent strength, it can be used for various utilities such as the formation of an ink receiving layer (image area) of a lithographic printing plate other than the formation of an image by the ink.

### (Radical Polymerization Based Ink Composition)

The radical polymerization based ink composition contains (d) a radical polymerizable compound, (e) a polymerization initiator, and (c) a colorant. As desired, the composition may further contain a sensitizing dye, a co-sensitizer, etc.

Hereinafter, components used in the radical polymerization based ink composition will be sequentially described.

(d) Radical Polymerizable Compound:

The radical polymerizable compound includes, for example, a compound containing an addition polymerizable ethylenically unsaturated bond as enumerated below.

### (Compound Containing an Addition Polymerizable Ethylenically Unsaturated Bond)

Examples of the compound containing an addition polymerizable ethylenically unsaturated bond which can be used in the ink composition of the invention include esters between an unsaturated carboxylic acid (for example, acrylic acid, methacrylic acid, itaconic acid, crotonic acid, isocrotonic acid, and maleic acid) and an aliphatic polyhydric alcohol compound and amides between the foregoing unsaturated carboxylic acid an aliphatic polyhydric amine compound.

Specific examples of monomers of an ester between an aliphatic polyhydric alcohol compound and an unsaturated carboxylic acid are as follows. That is, examples of acrylic esters include ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and polyester acrylate oligomers.

Examples of methacrylic esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(acryloxyethoxy)phenyl]dimethylmethane. Examples of itaconic esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic esters include ethylene glycol di-crotonate, tetramethylene glycol dicrotonate, pentaerythritol dicrotonate, and sorbitol tetradicrotonate. Examples of isocrotonic esters include ethylene glycol diisocrotonate, pentaerythritol diisocrotonate, and sorbitol tetraisocrotonate. Examples of maleic esters include ethylene glycol dimaleate, triethylene glycol dimaleate, pentaerythritol dimaleate, and sorbitol tetramaleate. In addition, mixtures of the foregoing ester monomers can be enumerated. Also, specific examples of monomers between an aliphatic polyhydric amine compound and an unsaturated carboxylic acid include methylene bisacrylamide, methylene bismethacrylamide, 1,6-hexamethylene bisacrylamide, 1,6-hexamethylene bismethacrylamide, diethylene triamine trisacrylamide, xylylene bisacrylamide, and xylylene bismethacrylamide.

As other examples, there are enumerated vinyl urethane compounds containing two or more polymerizable vinyl groups in one molecule thereof in which a hydroxyl group-containing vinyl monomer represented by the general formula (A): CH₂═C (R) COOCH₂CH (R′) OH (wherein R and R′ each represents H or CH₃) is added to a polyisocyanate compound containing two or more isocyanate groups in one molecule thereof, as described in JP-B-48-41708.

Furthermore, there can be enumerated functional acrylates and methacrylates such as urethane acrylates as described in JP-A-51-37193; polyester acrylates as described in JP-A-48-64183, JP-B-49-43191, and JP-B-52-30490; and epoxy acrylates resulting from a reaction between an epoxy resin and (meth) acrylic acid. In addition, compounds presented as photo curable monomers and oligomers in Journal of the Adhesion Society of Japan, Vol. 20, No. 7, pp. 300-308 (1984) can be used. In the invention, these monomers can be used in a chemical morphology such as prepolymers, namely dimers and trimers, oligomers, and mixtures or copolymers thereof.

The amount of use of the radical polymerizable compound is usually from 1 to 99.99%, preferably from 5 to 90.0%, and more preferably from 10 to 70% (the term “%” means % by weight) with respect to the whole of components of the ink composition.

### (Photopolymerization Initiator)

Next, the photopolymerization initiator which is used in the radical polymerization based ink composition of the invention will be hereunder described.

The photopolymerization initiator in the invention is a compound capable of generating a chemical change via an action of light or a mutual action with an electron excited state of a sensitizing dye to form at least one of radicals, acids and bases.

Preferred examples of the photopolymerization initiator include (a) aromatic ketones, (b) aromatic onium salt compounds, (c) organic peroxides, (d) hexaacryl biimidazole compounds, (e) keto oxime ester compounds, (f) borate compounds, (g) azinium compounds, (h) metallocene compounds, (i) active ester compounds, and (j) compounds containing a carbon-halogen bond.

### (Sensitizing Dye)

In the invention, for the purpose of improving the sensitivity of the photopolymerization initiator, a sensitizing dye maybe added. As the preferred sensitizing dye, there can be enumerated the following compounds which have an absorption wavelength in a region of from 350 nm to 450 nm.

That is, examples of the sensitizing dye include polynuclear aromatic compounds (for example, pyrene, perylene, and triphenylene), xanthenes (for example, Fluororescein, Eosine, Erythrocin, Rhodamine B, and Rose Bengale), cyanines (for example, Thiacarbocyanine and Oxacarbocyanine), merocyanines (for example, merocyanine and carbomerocyanine), thiazines (for example, Thionine, Methylene Blue, and Toluidine Blue), acridines (for example Acridine Orange, chloroflavin, and acriflavin), anthraquinones (for example, anthraquinone), squaryliums (for example, squarylium), and coumarins (for example, 7-diethylamino-4-methylcoumarin).

### (Cosensitizer)

In addition, known compounds having actions such as an action to further improve the sensitivity and an action to control the polymerization inhibition due to oxygen may be added as a cosensitizer in the ink of the invention.

Examples of such a cosensitizer include compounds as described in M. R. Sander, et al., Journal of Polymer Society, Vol. 10, p. 3173 (1972), JP-B-44-20189, JP-A-51-82102, JP-A-52-134692, JP-A-59-138205, JP-A-60-84305, JP-A-62-18537, JP-A-64-33104, and Research Disclosure, No. 33825. Specific examples thereof include triethanolamine, ethyl p-dimethylaminobenzoate, p-formyldimethylaniline, and p-methylthiodimethylaniline.

As other examples, there are enumerated thiols and sulfides, for example, thiol compounds as described in JP-A-53-702, JP-B-55-500806, and JP-A-5-142772 and disulfide compounds as described in JP-A-56-75643. Specific examples thereof include 2-methylmercaptobenzothiazole, 2-mercaptobenzoxazole, 2-methylmercaptobenzimidazole, 2-mercapto-4 (3H)-quinazoline, and β-mercaptonaphthalene.

As other examples, there are enumerated amino acid compounds (for example, N-phenylglycine), organometallic compounds as described in JP-B-48-42965 (for example, tributyl tin acetate), hydrogen donators as described in JP-B-55-34414, sulfur compounds as described in JP-A-6-308727 (for example, triathiane), phosphorus compounds as described in JP-A-6-250387 (for example, diethyl phosphite), and Si—H and Ge—H compounds as described in Japanese Patent Application No. 6-191605.

Furthermore, from the viewpoint of enhancing the preservability, it is preferred to add a polymerization inhibitor in an amount of from 200 to 20,000 ppm. It is preferable that the ink for inkjet recording of the invention is made to have a low viscosity by heating at a temperature in the range of from 40 to 80° C. and then injected. For the purpose of preventing headplugging by thermal polymerization from occurring, it is preferred to add a polymerization inhibitor. Examples of the polymerization inhibitor include hydroquinone, benzoquinone, p-methoxyphenol, TEMPO, TEMPOL, and cupferron Al.

### (Others)

Besides, known compounds can be used as the need arises. For example, surfactants, leveling additives, matting agents, and polyester based resins, polyurethane based resins, vinyl based resins, acrylic resins, rubber based resins, and waxes for the purpose of adjusting film physical properties can be properly selected and used. Furthermore, for the purpose of improving adhesion to a medium to be recorded such as polyolefins and PET, it is also preferred to contain a tackifier which does not inhibit the polymerization. Concretely, the tackifier includes high molecular adhesive polymers as described on pages 5 to 6 of JP-A-2001-49200 (for example, copolymers made of an ester between (meth) acrylic acid and an alcohol containing an alkyl group having from 1 to 20 carbon atoms, an ester between (meth) acrylic acid and an alicyclic alcohol having from 3 to 14 carbon atoms, or an ester between (meth)acrylic acid and an aromatic alcohol having from 6 to 14 carbon atoms) ; and low molecular tackiness-imparting resins containing a polymerizable unsaturated bond.

Furthermore, for the purpose of improving adhesion to the medium to be recorded, it is also effective to add an extremely trace amount of an organic solvent. In this case, it is effective to add the organic solvent in an amount within the range where problems in solvent resistance and VOC are not caused. Its amount is preferably in the range of from 0.1 to 5% by weight, and more preferably from 0.1 to 3% by weight with respect to the whole of the ink composition.

Furthermore, as a measure for preventing a lowering of the sensitivity due to a light shielding effect of the ink coloring material, it is also one of the preferred embodiments to form a radical/cation hybrid type curing ink by combining a cationic polymerizable monomer having a long life as a polymerization initiator and a polymerization initiator.

### (Aqueous Ink Composition)

An aqueous ink composition contains a polymerizable compound and a water-soluble photopolymerization initiator capable of generating a radical by the action of active energy rays. If desired, the aqueous ink composition may further contain a coloring material and the like.

### (Polymerizable Compound)

As the polymerizable compound which is contained in the aqueous ink composition of the invention, polymerizable compounds which are contained in known aqueous ink compositions can be used.

In order to optimize a formulation while taking into account end user characteristics such as curing rate, adhesion and flexibility, a reactive material can be added in the aqueous ink composition. As such a reactive material, for example, (meth)-acrylate (namely, acrylate and/or methacrylate) monomers and oligomers, epoxides, and oxetanes are useful.

Examples of the acrylate monomer include phenoxyethyl acrylate, octyldecyl acrylate, tetrahydrofurfuryl acrylate, isobornyl acrylate, hexanediol diacrylate, trimethylolpropane triacrylate, pentaerythritol triacrylate, polyethylene glycol diacrylates (for example, tetraethylene glycol diacrylate), dipropylene glycol diacrylate, tri(propylene glycol) triacrylate, neopentyl glycol diacrylate, bis(pentaerythritol) hexaacrylate, acrylates of an ethoxylated or propoxylated glycol and a polyol (for example, propoxylated neopentyl glycol diacrylate and ethoxylated trimethylolpropane triacrylate), and mixtures thereof.

Examples of the acrylate oligomer include ethoxylated polyethylene glycol, ethoxylated trimethylolpropane acrylate, polyether acrylate and ethoxylated products thereof, and urethane acrylate oligomers.

Examples of the methacrylate include hexanediol dimeth-acrylate, trimethylolpropane trimethacrylate, triethylene glycol dimethacrylate, diethylene glycol dimethacrylate, ethylene glycol dimethacrylate, 1,4-butanediol dimethacrylate, and mixtures thereof.

The amount of addition of the oligomer is preferably from 1 to 80% by weight, and more preferably from 1 to 10% by weight with respect to the whole weight of the ink composition.

### (Water-Soluble Photopolymerization Initiator Capable of Generating a Radical by the Action of Active Energy Rays)

The polymerization initiator which can be used in the ink composition of the invention will be hereunder described. As one example, there are enumerated photopolymerization initiators having a wavelength of up to approximately 400 nm. Examples of such a photopolymerization initiator include photopolymerization initiators represented by the following general formulae, which are a substance having functionality in a long wavelength region, namely sensitivity so as to generate a radical by irradiation with ultraviolet rays (hereinafter abbreviated as “TX base”). In the invention, it is especially preferred to properly select and use a compound among these polymerization initiators.

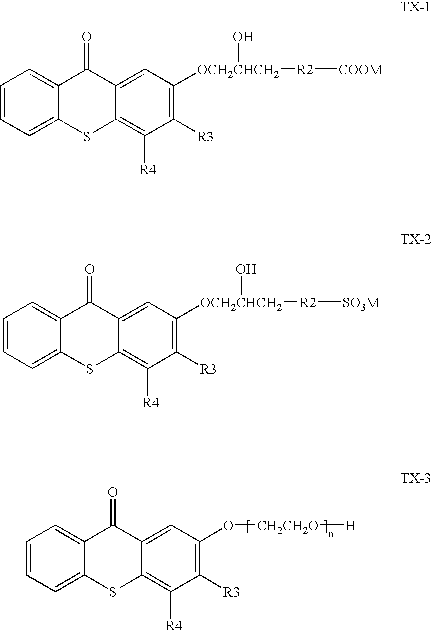

In the foregoing general formulae TX-1 to TX-3, R2 represents —(CH₂)ₓ— (wherein x represents 0 or 1), —O—(CH₂)_{y}— (wherein y represents 1 or 2), or a substituted or unsubstituted phenylene group. Furthermore, when R2 represents a phenylene group, at least one of hydrogen atoms in the benzene ring may be substituted with one or two or more groups or atoms selected from, for example, a carboxyl group or a salt thereof, a sulfonic acid or a salt thereof, a linear or branched alkyl group having from 1 to 4 carbon atoms, a halogen atom (for example, fluorine, chlorine, and bromine), an alkoxyl group having from 1 to 4 carbon atoms, and an aryloxy group such as phenoxy group. M represents a hydrogen atom or an alkali metal (for example, Li, Na, and K). In addition, R3 and R4 each independently represents a hydrogen atom or a substituted or unsubstituted alkyl group. Here, examples of the alkyl group include linear or branched alkyl groups having from approximately 1 to 10 carbon atoms, and especially from approximately 1 to 3 carbon atoms. Furthermore, examples of the substituent of the alkyl group include a halogen atom (for example, a fluorine atom, a chlorine atom, and a bromine atom), a hydroxyl group, and an alkoxyl group (for example, alkoxyl groups having from approximately 1 to 3 carbon atoms). Moreover, m represents an integer of from 1 to 10.

In addition, in the invention, water-soluble derivatives of a photopolymerization initiator, IRGACURE 2959 (a trade name, manufactured by Ciba Specialty Chemicals) represented by the following general formulae can be used. Concretely, a photopolymerization initiator composed of the following formulae IC-1 to IC-3 can be used.

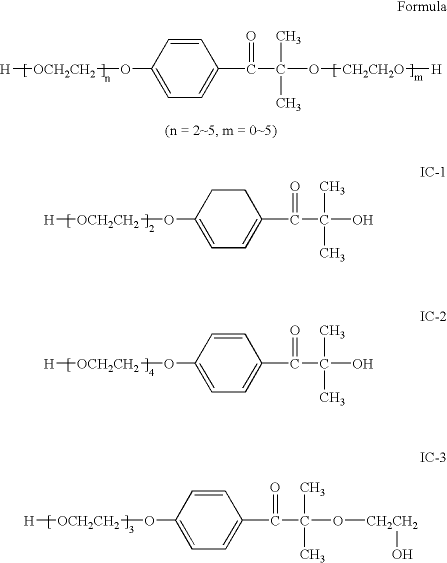

### (Formulation for Clear Ink)

By forming the foregoing water-soluble polymerizable compound into a transparent aqueous ink without containing the foregoing coloring material therein, it is possible to prepare clear ink. In particular, by preparing the ink so as to have inkjet recording characteristics, a water-soluble curing type clear ink for inkjet recording is obtained. When such an ink is used, since it does not contain a coloring material therein, a clear film can be obtained. Examples of the utilization of the coloring material-free clear ink include use for undercoating for the purpose of imparting adaptability to image printing to a material to be recorded and use for overcoating for the purposes of surface protection of an image as formed by a usual ink and decoration and gloss impartation. In response to these uses, it is also possible to disperse a colorless pigment or a fine particle not for the purpose of coloration, and the like. By adding such substances, it is possible to improve various characteristics such as image quality, fastness and processability (for example, handling properties) of a printed matter.

With respect to the formulation condition in applying such a clear ink, it is preferred to prepare the ink so as to contain from 10 to 85% of the water-soluble polymerizable compound as the major component of the ink and from 1 to 10 parts by weight, based on 100 parts by weight of the water-soluble polymerizable compound, of the photopolymerization initiator (for example, an ultraviolet ray polymerization catalyst), with the photopolymerization initiator being contained in an amount of at least 0.5 parts based on 100 parts of the ink.

### (Material Construction in Coloring Material-Containing Ink)

In the case of using the foregoing water-soluble polymerizable compound for a coloring material-containing ink, it is preferred to adjust the concentrations of the polymerization initiator and the polymerizable substance in the ink adaptive to the absorption characteristics of the coloring material which has been contained. As described previously, with respect to the blending amount, the amount of water or the solvent is made to fall within the range of from 40% to 90%, and preferably from 60% to 75% on the weight basis. In addition, the content of the polymerizable compound in the ink is in the range of from 1% to 30%, and preferably from 5% to 20% on the weight basis with respect to the whole amount of the ink. The amount of the polymerization initiator relies upon the content of the polymerizable compound and is generally in the range of from 0.1 to 7%, and preferably from 0.3 to 5% on the weight basis with respect to the whole amount of the ink.

In the case where a pigment is used as the coloring material of the ink, the concentration of the pure pigment fraction in the ink is generally in the range of from 0.3% by weight to 10% by weight with respect to the whole amount of the ink. The coloring power of the pigment relies upon the dispersed state of the pigment particle. The range of from about 0.3 to 1% is the range where the ink is used as an ink of a pale color. When the concentration exceeds this range, a concentration at which the ink is used for general coloration of colors is given.

The present application claims foreign priority based on Japanese Patent Application (JP 2006-034078) filed Feb. 10 of 2006, the contents of which is incorporated herein by reference.

What is claimed is:

1. An ink-jet recording apparatus comprising:
a recording medium transporting portion that transports a web-like recording medium;
ink-jet heads that comprise a nozzle portion and ejects an ink on the basis of an image signal toward the web-like recording medium transported by the recording medium transporting portion, the ink being curable by active energy rays;
an active energy irradiating portion that comprises a light source irradiating the active energy rays and cures the ink ejected onto the web-like recording medium by the active energy rays irradiated from the light source; and
a transporting direction changing portion that is disposed right by at least one of an upstream and downstream sides of the active energy irradiating portion in the transporting direction of the recording medium at a position between ink-jet heads, and that changes a transporting direction of the recording medium to a direction vertical to the transporting direction.

2. The ink-jet recording apparatus as claimed in claim 1, wherein the light source of the active energy irradiating portion is positioned below a horizontal plane including the nozzle portion of the ink-jet head.

3. The ink-jet recording apparatus as claimed in claim 1, wherein the transporting direction changing portion comprises a roller.

4. The ink-jet recording apparatus as claimed in claim 3, wherein the roller is heated to from 40 to 150° C.

5. The ink-jet recording apparatus as claimed in claim 1, which comprises a light-shielding cover extending between upstream and downstream transportation rollers, the light-shielding cover being disposed behind the active energy irradiating portion.
